(19) United States
(12) Patent Application Publication
(10) Pub. No.: US 2011/0177331 A1
(43) Pub. Date: Jul. 21, 2011

(54) Self-adhesive repair patch

(76) Inventor: Wayne Charles Mosher, Saint Louis, MO (US)

(21) Appl. No.: 12/657,257

(22) Filed: Jan. 15, 2010

(51) Int. Cl. B32B 7/12

(52) U.S. Cl. 428/354

(57) ABSTRACT

A self-adhesive weather resistant patch usable indoors or outdoors to repair holes and slits in the body panels of freight trailers and other relatively smooth non-pliable surfaces employed by peeling off a protective layer from the adhesive side of the patch, positioning the patch over the damaged area, and applying hand pressure to seat the patch.

### BACKGROUND

1. Field of Invention

This invention is concerned with a self-adhesive, formable repair patch, which can be applied in one simple step to create a complete, weather-tight, repair of a hole or split in a damaged non-pliable surface indoors or outdoors. The article is to be employed to add strength to a surface while sealing a breach in the surface to restore its resistance to water, solvents, dirt, and other contaminants.

2. Description of Prior Art

On Sep. 17, 2008, I was driving from Saint Louis, Mo. to Pittsburgh, Pa. and noticed something about the van style trailers and box style straight trucks that were sharing the highway with me. Nearly half of them had holes in the cargo compartment. Many of the holes had not been repaired. This allowed water and road grime to enter the cargo compartment with possible damage to the items being shipped. Those that were repaired either had inadequate patches such as tape or a smear of caulk or showed the signs of extensive time spent and the need to remove the vehicle from service so that the repair could be performed in a shop. It was common to observe that a crude patch with square corners had been cut out of aluminum using tin snips and had been riveted or screwed into place. Sometimes, there were indications that some caulk had been applied in between the patch and the surface being repaired. Not counting the opportunity cost of the time the vehicle was out of service, I estimate the actual time spent in making the repairs to be one hour for small holes to two hours for larger ones. I said to myself, “I bet I can make that task easier and with a result that is better.” Then I recalled a program on television titled “Adhesives” I had recently watched. It provided an overview of many adhesives' characteristics, strengths, and weaknesses. Suddenly, I knew how I could make a better repair patch using a visco-elastic adhesive featured on the TV show and a machine formed aluminum sheet with rounded corners for a professional appearance. I developed the invention over the next several months by experimenting with various thicknesses, tempers, and alloys of aluminum, sources and forms of adhesive, means of cutting out the aluminum sheet and methods of attaching the adhesive layer. I found that a roll of aluminum could have the adhesive applied and then be slit to width. The resulting multilayer intermediate form could then be fed through a punch press using hard tooling to form the desired shape. I, Wayne Charles Mosher, submitted an application for a provisional patent titled “Self-adhesive Repair Patch”. It was issued as No. 61/205,175 with a filing date of Jan. 16, 2009 and I claim that date.

Since then, I have further developed the invention into a nicely finished marketable form, created consumer packaging, and approached numerous outlets, which are evaluating the Product for inclusion in their stores and catalogs.

Currently, I make my invention using the following method:

Aluminum alloy H143105 is received pre-painted in rolls 12½ inches wide by 0.025±0.008 inches. Special 3M™ VHB™ 4941F adhesive is received in rolls 12¼ inches wide by 0.045±0.003 inches. Allowing for a small amount of exposed aluminum on each edge, the adhesive (with the liner attached) is rolled carefully onto the unpainted side of the aluminum alloy to form a laminated intermediate feedstock having a painted surface on one side and a plastic liner membrane on the other. The resultant feedstock is re-rolled. Next, the feedstock is run through a metal slitting machine using standard knives and spacers where a narrow edge (0.25 inches) is cut off on each side and the remainder is slit down the middle to obtain feedstock that is covered by adhesive from edge to edge and to obtain the exact width needed for punch press cutting (6 inches) and is re-rolled. Then, the feedstock is run through a punch press having an automatic feed to control the length of items and to flatten the feedstock before cutting using custom hard tooling. Items are punched out to the proper length and form including the corner radii.

A strong argument that my invention is unique and not obvious can be made simply by observing that an obvious need has not been filled. The need as readily seen is the sealing of holes in cargo compartments of ubiquitous freight trucks and trailers. I have also re-searched prior patents to ensure that my invention is unique and not obvious. I found no conflicting patents. Specifically, (in order of patent number) I found the following:

| | Patent | | Issue | Patent |
|---|---|---|---|---|
| U.S. Pat. No. | Class | Inventor | Date | Thrust |
| 4,135,017 | 428/78 | Hoffmann, Sr.; | Jan. 16, 1979 | This patent deals with a patch for re- |
| | | Dennis | | pair of an interior wall surface using |
| | | | | plaster type materials. The patch is |
| | | | | attached to the wallboard only on the |
| | | | | periphery and provides support for a |
| | | | | skim coat of plaster. The outer sur- |
| | | | | face of the patch is not finished but is |
| | | | | adapted for receiving a plaster finish. |
| | | | | This patch is to be used on an interior |
| | | | | wall. No sealing function is claimed. |
| | | | | No ability to use outdoors is claimed |
| | | | | and the paper used would not hold up |
| | | | | to weather or to stress. |
| 4,707,391 | 428/63 | Hoffmann, Sr; | Nov. 17, 1987 | This patent describes a perforated |
| | | Dennis | | plate to add strength to conventional |
| | | | | auto body repair using repair com- |
| | | | | pound but does not combine the plate |
| | | | | with other components before using it |
| | | | | as a self sufficient patch. |
| 5,075,149 | 428/138 | Owens; R, Larry | Dec. 24, 1991 | A patch for the repair of a hole in an |
| | | et al. | | interior wall. The patch has a pressure |
| | | | | sensitive adhesive layer which can be |
| | | | | affixed to the wall surrounding the |
| | | | | hole. Perpheral portions of the patch |
| | | | | are thinner than that portion disposed |
| | | | | over the hole itself and the outer sur- |
| | | | | face of the patch is flat. This configu- |
| | | | | ration has two weaknesses; in order |
| | | | | for the outer surface to remain flat de- |
| | | | | spite a central section that is thicker, |
| | | | | the central portion must be recessed |
| | | | | into the wall by cutting away portions |
| | | | | of the wall so that only the periphery |
| | | | | of the patch contacts the wall surface, |
| | | | | and the patch cannot be adjusted in |
| | | | | size by trimming because that proce- |
| | | | | dure would remove the tapering por- |
| | | | | tions of the preiphery. |
| 5,620,768 | 428/77 | Hoffmann, Sr.; | Apr. 15, 1997 | This patent describes multiple stages |
| | | Dennis | | of application rather than a single, |
| | | | | simple step. |
| 7,316,835 | 428/63 | Swanson; Randall | Jan. 8, 2008 | This patent describes a wall patch for |
| | | Eric | | cosmetic interior use that includes a |
| | | | | body with a lower surface and an up- |
| | | | | per surface. An adhesive is located on |
| | | | | the lower surface to secure the wall |
| | | | | patch to a wall surface. The upper sur- |
| | | | | face is ready-to-paint and can also be |
| | | | | pre-textured, if desired. An optional |
| | | | | center reinforcement can be a rigid |
| | | | | plastic or metal wall patch, or a flexi- |
| | | | | ble plastic or fibered paper wall patch, |
| | | | | without a textured upper surface. The |
| | | | | article does not result in a completed |
| | | | | structural patch but requires addition- |
| | | | | al steps to cover the article with paint |
| | | | | and blend it in. |
| 7,380,382 | 52/514 | Hansen; Daniel R. | Jun. 3, 2008 | This patent requires addition of a |
| | | | | second component (water) to a mesh |
| | | | | screen for repair of drywall - does not |
| | | | | accomplish a finished repair upon ap- |
| | | | | plication of the patch. |
| 7,470,339 | 156/71 | Hoffmann, Sr.; | Dec. 30, 2008 | This patent describes a way to apply |
| | | Dennis et al. | | adhesive to a wall surface to facilitate |
| | | | | repair but does not describe an article |
| | | | | to actually accomplish repair. |

Objects and Advantages

My observation of others' inadequate patching of vehicle side panels convinces me that there will be a commercially successful opportunity to further develop and market a cost saving repair patch that is permanent, usable indoors or outdoors, good looking with professional finish, and quick to apply. The cost savings from the employment of my invention will accrue initially to the person or company using my invention but ultimately, the savings will be passed along to our society and economy in general because the savings to the users can result in lower prices for goods or services to their customers without a decrease in profit. That is my object. My invention will work not only on vehicles as originally conceived but will make it easy and quick to repair surfaces made of virtually any relatively smooth material such as bare or painted metal, plastic, ceramic, or glass. Using a versatile, pre-applied pressure sensitive adhesive as a means of affixing the patch eliminates the need to use a separate step to apply adhesive during the patching process and provides a weather-tight patch appropriate for repairs outside as well as inside. Likewise, it is not necessary to mechanically hold my invention in place using screws, bolts, rivets, welding or the like, thereby improving the appearance. These two features will result in saving time and effort and in making a permanent repair easy for an untrained or inexperienced person to accomplish. The completed patch is highly resistant to breakdown due to aging as well as to water (including salt water), harsh detergent solutions applied using pressure washers, most solvents, road grime, other contaminants that defeat other patches.

Though it is simple in its basic concept and relatively easy to describe using just one drawing, no one has thought of it before. My invention is not obvious and has the potential to be a breakthrough in the art and practice of repairing surfaces especially on vehicles.

Further objects and advantages of my invention will become apparent from a consideration of the drawing and ensuing description.

### DRAWING FIGURE

FIG. 1 shows my invention in one of its possible configurations—a rectangular shape with three layers and rounded corners. This is my preferred form but to solve a variety of problems, my invention can be manufactured in any shape and can have more than three layers as will be detailed in Claims.

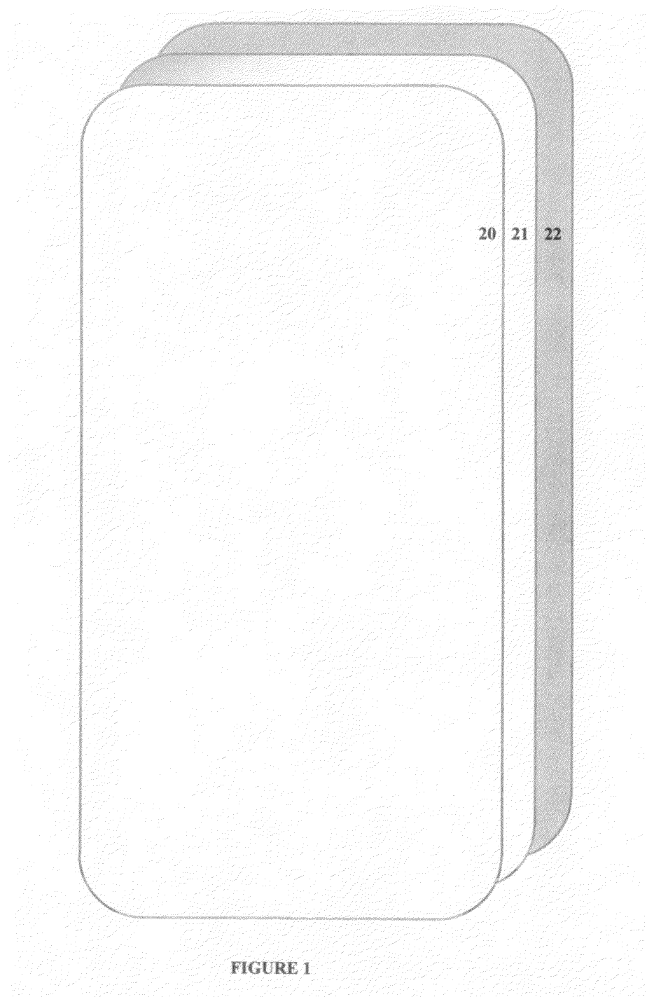

### REFERENCE NUMERALS IN DRAWING

20 Outer structural layer

21 Intermediate adhesive layer permanently affixed to structural layer

22 Inner removable layer to protect adhesive from contamination

### EXAMPLE AND DESCRIPTION

As discussed in Background—Description of Prior Art above, one satisfactory example of the employment of my invention is to use an appropriate size and shape to repair the holes and slits in the outer skins of the cargo compartments of freight trailers and trucks. My invention is extremely versatile and has many other uses including repair of rain gutters and downspouts; air conditioning and heating ducts; machine cabinets or housings; water troughs; automobile, RV, ATV, and truck bodies; hard sided luggage, sample cases, and shipping containers; metal or plastic building siding or roofs—virtually any smooth surface.

Operation

To employ my invention, ensure that the surface to be repaired is free of oils, greases, soils, and loose rust that would prevent good adhering by the adhesive. Then, simply peel off the innermost protective layer to expose the adhesive and affix the repair patch pressing firmly with fingertips or the palm of the hand to help the adhesive make full contact with the surface being repaired. The item being repaired does not need to be taken out of service and can be permanently repaired in one quick, cost saving step.

Alternative Embodiments

The structural layer can be made as a single layer or as several layers laminated together to provide the needed degree of strength, rigidity, or flexibility. The structural layer can be stiff or formable. The materials used in the structural layer can be metals, plastics, carbon fiber composites, glass fiber composites, ceramics or the like. The structural layer can be flat or pre-formed into any shape. The structural layer can be uniform in thickness or can be of varying thickness as needed for particular applications e.g. tapering toward the outer edges to allow the repair patch to blend in with the surface being patched. The adhesive layer can be uniform in thickness or can be of varying thickness as needed for particular applications e.g. tapering toward the outer edges to allow it to blend in with the surface being patched. The adhesive layer can be made as a single layer or as multiple layers laminated together to provide improved adhesion. For example, one layer of adhesive might be selected based on its ability to adhere to the structural layer of the repair patch and a second layer of adhesive might be added to the first layer of adhesive in a planar way based on the second adhesive layer's greater ability to adhere to the surface being repaired.

Conclusion, Ramifications, and Scope

As can be seen, my invention, usable indoors or outdoors, is applicable to repairing by means of patching any surface to which the selected pressure sensitive adhesive adheres. Using my invention is fast, easy, and time saving thereby making the decision to buy and use it easy to make.

The scope of the invention should be determined by the appended claims and their legal equivalents rather than by the examples given.

I claim:

1. A self-adhesive repair patch that is a flat, rectangular, laminated article with rounded corners for use in repairing by patching any clean non-pliable surface indoors or outdoors and consisting of at least three layers at least one of which provides strength and shape retention, at least one of which provides pressure sensitive adhesion, and at least one of which provides protection against contamination of the outermost layer of adhesive and having all layers be of uniform thickness and of full edge to edge coverage of the adjacent layer.

2. The self-adhesive repair patch of claim 1 improved by being non-flat.

3. The self-adhesive repair patch of claim 1 and claim 2 improved by being non-rectangular.

4. The self-adhesive repair patch of claim 1, claim 2, and claim 3 improved by having at least one layer be non-uniform in thickness.

5. The self-adhesive repair patch of claim 1, claim 2, claim 3, and claim 4 improved by having at least one layer not extend fully edge to edge of the adjacent layer.

6. The self-adhesive repair patch of claim 1, claim 2, claim 3, claim 4, and claim 5 improved by having corner shapes other than rounded corners.

7. The self-adhesive repair patch of claim 1, claim 2, claim 3, claim 4, claim 5, and claim 6 improved by having the adhesive not be pressure sensitive but be activated before use by the application to it of an activating modifier.
